(19) United States
(12) Patent Application Publication
(10) Pub. No.: US 2004/0243833 A1
(43) Pub. Date: Dec. 2, 2004

(54) Method and apparatus for securing a computer system

(76) Inventor: Simon Alan Spacey, London (GB)

Correspondence Address: SIMON ALAN SPACEY, SUITE 94, 2 LANSDOWNE ROW, LONDON, WIJ GHL, GB

(21) Appl. No.: 10/717,444

(22) Filed: Nov. 21, 2003

(30) Foreign Application Priority Data
May 27, 2003 (GB) 0312112.6

(51) Int. Cl. H04L 9/00

(52) U.S. Cl. 713/200

(57) ABSTRACT

This invention presents a method and apparatus for securing a computer system by bounds and other run-time checks. The method can be implemented in hardware to remove the performance penalties previously associated with run-time checks.

### BACKGROUND OF THE INVENTION

This invention concerns the security of computer systems. In particular it concerns the protection of computer systems from buffer overflow attacks and other run-time issues. The patent assumes the reader is already familiar with the anatomy of buffer overflow attacks and has a good understanding of compiler technologies, microchip technologies and computer systems in general.

Over the last decade many methods to prevent buffer overflow attacks have been invented. These methods can be divided into 5 categories: Safe Execution Environments, Safe Libraries, Bug Detection, Stack Protection and Code Instrumentation. Examples of the first three categories are: Cyclone, Libsafe and Electric Fence respectively. These methods all have disadvantages in either use, performance or the level of protection they provide.

Examples of the Stack Protection methods include: ProPolice (U.S. pat. app. 20010013094), StackGuard and Stack Shield. These methods work by protecting the return address in the activation frame and typically have a performance penalty of less than 10% but they only protect the stack and do not provide any heap overflow protection.

Full buffer overflow protection is provided by Code Instrumentation methods. One such method is the Free Software Foundation's GCC Bounded Pointers project. This protection method works by (1) augmenting every pointer with the low and high bound of the memory, item to which the pointer is seated and (2) inserting instrumentation code into the executable that checks the pointer's value is between these bounds before allowing access to the referenced memory location. Advantageously the method provides protection for both stack and the heap overflows but it has the disadvantage that it breaks the current C programming convention that pointers and ints have the same size. The method also suffers from a reported performance penalty of around 100%.

This invention presents a new method for protecting computer systems from buffer overflow attacks and other program issues. The method is in the category of Code Instrumentation and provides full buffer overflow protection. The preferred embodiment requires changes to both the hardware and software of a system and performs the bounds checking directly in the modified hardware so removing the need for instrumentation code in the software and removing the performance penalties associated therewith. However, a software only embodiment is also possible.

### BRIEF SUMMARY OF THE INVENTION

It is an object of the present invention to provide a method and apparatus for securing a computer system. The method as presented will provide facilities for run-time bounds and other program checks that can be implemented at either the hardware or software level. The method retains the conventional size and form of pointers.

These and other objects, advantages and features of the present invention are provided by a new method for storing and referencing memory items in a computer system comprising 3 steps:

1. Selected memory items are augmented with a Memory Item Header (MIH). The memory items of interest are items that will be referenced by pointers and could include functions, buffers, objects and data. The MIH contains the length of the memory item and optionally other information such as the item's type, access rights, id and reference counts. The length of a function may be recorded as 1 in its MIH to give only a single valid reference point.

2. Traditional pointers that would have referenced a memory location directly are replaced with a new construct termed a Pointer to an Intermediary Pointer Object (PIPO). The PIPO has the same form as a traditional pointer but references a newly constructed Intermediary Pointer Object (IPO) instead of a memory location directly. The IPO contains the information of the actual location being referenced in two parts: the address of a MIH and an offset to the actual location being referenced with regard to that MIH.

3. Run-time PIPO dereferencing is accompanied by checks to verify that the offsets applied there and in the IPO are within the length of the memory item as stored in its MIH. These run-time checks can be performed at either the hardware or software level.

In a method according to the invention, the MIH differ from type tags (see U.S. Pat. No. 5,283,870) and symbol table entries in that they contain the object length, are augmented to memory items and are associated with run-time storage locations.

In a second method according to the invention, the pointer construction differs from that of Bounded Pointers in that there is an extra layer of indirection through the new Intermediary Pointer Objects (IPOs) disclosed herein. Like Bounded Pointers these new IPOs contain the start address of the memory item being referenced (more accurately the MIH address), but they do not contain either the end bounds address of the memory item or the absolute direct location being referenced as required by Bounded Pointers. Instead the new IPOs contain an offset to the location being referenced with regard to the MIH. Advantageously this indirection keeps the PIPO pointers the same size and form as traditional pointers.

In a preferred embodiment of the system according to the invention, bounds checking is performed on access through PIPOs by instrumentation implemented in the computer system's hardware. Here the traditional software pointers of the computer program are altered at compile time to act through the new IPO/MIH construct and the program is executed on hardware capable of utilising the new construct.

In a second embodiment of the system according to the invention bounds checking is performed by instrumentation implemented in software. Here the implementation requires specially compiled software with PIPOs acting through the new IPO/MJH construct as in the preferred embodiment, but it does not require special hardware to execute. The hardware bounds checking functionality is instead inserted as extra code in the executable software and runs on a traditional CPU. The extra code checks that PIPO dereference attempts are consistent with the information continued in the corresponding IPO and MIH and calls an appropriate error handling routine if not.

Those skilled in the art will further appreciate that the invention is not limited by the structure of the Memory Item Header. Additional items such as type flags, access rights, object ids and reference counts can be included in the header to allow additional run-time checks. It is clear also that the header can be implemented as a group of computer bytes, bit fields, modified tags, memory maps or in any number of other ways.

### DETAILED DESCRIPTION

An embodiment of the invention will now be disclosed, without the intention of a limitation, in a computer system for the prevention of buffer overflow attacks on the following C code fragment:

| | |
|---|---|
| 01 | const char pass [] = “password”; |
| 02 | char buff[8]; |
| 03 | int c; |
| 04 | int i = 0; |
| 05 | |
| 06 | while((c = getchar( )) != EOF && c != ‘\n’) |
| 07 | { |
| 08 | buff[i] = c; |
| 09 | i++; |
| 10 | } |
| 11 | |
| 12 | if(memcmp(buff, pass, 8) == 0) |
| 13 | printf(“Login OK\n”); |
| 14 | else |
| 15 | printf(“Login Error\n”); |

The weakness in this code fragment is in lines 02 and 08. Line 02 defines a buffer of 8 characters, but line 08 makes it possible to write beyond the buffer limit depending on the value of ‘i’. This issue is especially troublesome here because normal compilers would place the variable ‘pass’ directly adjacent (and above) the variable ‘buff’ in run-time storage. Thus a user could actually overvrite and set the program password before it was tested. In this code fragment a hacker merely has to enter 16 characters for the password with the same first and last 8 characters such as ‘hackedithackedit’ to breach system security.

The problem lines might be compiled on an illustrative 32-bit architecture machine to the following intermediate representation:

| | | | |
|---|---|---|---|
| 02 | leal | −48(%ebp), %esi | # char buff[8] |
| 08 | movb | %al, (%ebx,%esi) | # buff[i] := c |

Here the compiler has selected registers %al and %ebx to hold the variables ‘c’ and ‘i’ respectively and %esi holds the start address of the ‘buff’ character array. For clarity, the labels are line numbers of the original source program. Line 02 reserves 8 bytes for the ‘buff’ character array in the stack starting at −48(%ebp). In this example the data for the variable ‘pass’ starts at location −40(%ebp).

According to a first method of the invention, the ‘buff’ character array must be augmented by a MIH because it is referenced by a pointer (arrays are referenced by pointers in C). This is accomplished by prefixing the MIH to the memory item data. In the 32-bit architecture of the present example, the length of a memory item could theoretically require up to 32-bits to represent and so we will use a minimal MIH of 4 bytes here. Using a MIH that is a multiple of the computer word size is recommended as it helps to alleviate alignment issues.

Adding the MIH header to ‘buff’ can be accomplished as a modification to the compilation process resulting in altered intermediate code for line 02 illustrated below:

| | | | |
|---|---|---|---|
| 02 | leal | −48(%ebp), %esi | # char buff[8] |
| | leal | −52(%ebp), %esi | # %esi := &MIH |
| | movl | $8, (%esi) | # MIH.length := 8 |

Note that the extra 4 bytes for the MIH are allocated at −52(%ebp) and the original length of the memory item (i.e. 8) is placed in the newly allocated MIH. The length is measured in bytes and is always >=1 in this embodiment. This has the advantage that sizeof, copy and comparison operations can be enhanced accordingly.

In the second method of the invention the traditional direct %esi pointer is replaced by a PIPO pointing to a newly constructed IPO intermediary. The new IPO requires storage sufficient for an offset and the address of a MIH. The minimal IPO used here is thus 8 bytes in size (2 32-bit values). The new IPO can be constructed on the stack as a further change to the intermediate code of line 02:

| | | | |
|---|---|---|---|
| 02 | leal | −48(%ebp), %esi | # char buff[8] |
| | leal | −52(%ebp), %esi | # %esi := &MIH |
| | movl | $8, (%esi) | # MIH.length := 8 |
| | movl | %esi, −56(%ebp) | # IPO.pMIH := &MIH |
| | movl | $0, −60(%ebp) | # IPO.offset := 0 |
| | leal | −60(%ebp), %esi | # %esi := &IPO |

As a result of these modifications, %esi ends up being a PIPO pointing to the newly constructed IPO. The new IPO is located at −60(%ebp) and has two parts: an offset of zero (indicating the first data element of ‘buff’) and the address of the MIH for the ‘buff’ array. The offset is stored at the head of the IPO before the MIH address in this embodiment.

In the third method of the invention, the new PIPO construction is used for bounds checking at run-time. This can be accomplished by hardware or software means. For the purpose of a first illustration, the software implementation of this method will now be disclosed with reference to the example code fragment. The implementation presented checks only for violations of the upper limit of the ‘buff’ array but it is clear that lower bound checks can be implemented similarly.

The software level checking for line 08 is shown below in intermediate code:

| | | | |
|---|---|---|---|
| 08 | movl | (%esi), %ecx | # %ecx := IPO.offset |
| | addl | %ebx, %ecx | # %ecx += i |
| | movl | 4(%esi), %edi | # %edi : = &MIH |
| | cmpl | (%edi), %ecx | # MIH.length > %ecx ? ok : error |
| | jb | .assign | |
| | .error: | | |
| | subl | $12, %esp | |
| | pushl | $1 | # set EXIT_FAILURE |
| | call | exit | # call exit |
| | .ok: | | |
| | addl | $4, %ecx | # %ecx += sizeof(MIH) |
| | movb | %al, (%ecx, %edi) | # buff[i] := c |

In this implementation the process is halted on a bounds violation by an exit system call with failure status. This is simple but does not provide a means for the programmer to identify the source of the program issue. Alternatively then, in accordance with the methods of the invention, violations of checks can result in any combination of: core dumps, signals, interrupts, exceptions, loop breaks, log entries, resets, retries, honey pot redirections, e-mails to the administrator or other actions.

After reviewing the software level implementation of method 3 presented above in intermediate code, the reader may be forgiven for thinking that the new invention is more difficult to implement than Bounded Pointers. However, it should be clear that the method provides a systemised way to associate bounds information with traditionally sized pointers and that software level run-time checks can be implemented in a variety of ways including: modifications to the compilation process, run-time libraries, functions, macros, system calls and source translation. It should also be clear that the intermediate code presented has not been optimised.

However, in the preferred embodiment of method 3 the run-time checking is performed by hardware. This can be by new CPU instructions or modifications to the CPU microcode for existing instructions. Here the compiler does not have to produce the extra code for line 08 as presented above. Instead the CPU automatically implements the indirection of the invention through compiler constructed IPO/MIH objects for identified PIPO pointers.

In a modified CPU microcode embodiment, the machine can determine if it needs to execute the modified microcode version of an instruction if it is able to distinguish between new PIPO pointers and traditional pointers. This can be accomplished by various means in co-operations with the compilation changes that are still required to implement methods 1 and 2 of the invention. These means include: registers reserved for PIPOs, reserved memory areas for IPOs, tags, maps and new address modes.

An example of the hardware implementation of method 3 is now provided with reference to the foregoing. The compiler applies methods 1 and 2 to source code line 02 to create a MIH and IPO as before but now instead of putting the resulting PIPO pointer in the general register %esi, the compiler puts the pointer in a register reserved for PIPOs by the CPU. For the purposes of this illustration, this new register will be called %ipo. The compiler then generates intermediate code for line 08 using the new register %ipo as shown below:

08 movb %al, (%ebx,%ipo) # buff[i] := c

When the code is executed on hardware implementing method 3 of the invention, the hardware recognises that the register used in the implementation of line 08 is a PIPO reserved register. It therefore knows it must run the modified microcode version of ‘movb’to execute the indirection and checks of the invention through the IPO and MIH chain referenced by the %ipo register. The logic of this modified microcode is as already illustrated in the software level intermediate code embodiment. The hardware can issue an appropriate exception on bounds or other violation.

In yet another embodiment, the PIPO is changed to reference a MIH directly. This removes an IPO by assuming a fixed IPO offset of zero. The embodiment has the f removing one layer of indirection but, in assuming a fixed offset, it suffers when implementing code such as:

| | |
|---|---|
| 01 | const char pass[] = “password”; |
| 02 | char buff[8]; |
| 03 | int c; |
| 04 | char* pBuff = buff; |
| 05 | |
| 06 | while((c = getchar ( )) != EOF && c != ‘\n’) |
| 07 | { |
| 08 | *pBuff++ = c; |
| 09 | } |
| 10 | |
| 11 | if(memcmp(buff, pass, 8) == 0) |
| 12 | printf(“Login OK\n”); |
| 13 | else |
| 14 | printf(“Login Error\n”); |

In the earlier embodiments using the full IPO construct, line 08 immediately above is simply implemented as an increase to the offset value in the IPO for ‘pBuff’. In this embodiment however, line 08 needs to be transformed into a traditional buff [symbol] reference; said transformation requiring a new dedicated offset counter as illustrated below:

| | |
|---|---|
| 05 | int pBuff_offset=0; |
| 06 | while((c = getchar( )) != EOF && c != ‘\n’) |
| 07 | { |
| 08 | buff[pBuff_offset++] = c; |
| 09 | } |

As part the transformation, the compiler may optimise out the ‘pBuff’ variable in the and this would leave very similar code to that of the fragment presented at the document.

It is clear that both the IPO and no IPO modes of operation can be used simultaneously provided their PIPOs can be distinguished. This can be achieved by including magic numbers in the IPO and MIH objects, by new registers or by other means.

The preceding embodiments may carry a performance penalty due to the extra memory cycles required to access the intermediary objects. This penalty is clearly mitigated by hardware level bounds checking but can also be mitigated by other means. One such means is to only performing ‘important bounds checks’ such as the forward bound condition on character arrays. Another is to retain IPOs and/or MIHs in a CPU cache or in registers.

In an enhancement to the embodiments provided thus far, the offset in the IPO is taken from the start of the MIH and the memory item length held in the MIH is increased by the size of the MIH. This removes the following intermediate code from the software level implementation provided previously for line 08:

addl $4, %ecx # %ecx += sizeof(MIH)

In a further enhancement, the invention is used to perform additional run-time checks. To implement these additional checks extra information such as type flags, access rights, object ids and reference counts can be stored in the IPO or, preferably, the MIH.

By including access rights and type information it is possible to check for latent program issues such as: reads to uninitialised memory (marked as write only until initialised), the use of invalid function pointers (no execute flag) and inappropriate casts and arithmetic operations at run-time. Adding reference counts allows for automatic garbage collection and checking for orphaned memory items.

Several advantages and benefits of the invention will now be disclosed with reference to the illustrations already provided. It is a benefit of the invention that a memory item need only have one MIH and that this can contain additional information. A MIH can in turn be referenced by several IPOs even where these IPOs reference different offsets in the underlying memory item. It is a further benefit of the invention that a single IPO can be referenced by several PIPOs and that the PIPOs have the same size and form as traditional pointers. These benefits make it possible for traditional pointer passing, copying and comparison methods to be retained and enhanced when using the methods of the invention.

Along with the objects, advantages and features described, those skilled in the art will appreciate other objects, advantages and features of the present invention still within the scope of the claims as defined. For instance, it is easy to envisage embodiments that compress type, access and length information into a single computer word MIH and embodiments that group elements from the MIH and IPO into new objects.

We claim:

1. A method for securing a computer system, characterised by:
a) Augmenting selected memory items by Memory Item Headers (MIH)
b) Replacing traditional pointers to the selected memory items by Pointers to Intermediary Pointer Objects (PIPOs)
c) Validating references made to the memory items through the PIPOs at run-time

2. A method in accordance with claim 1, wherein said selected memory items can include functions, arrays, objects, fundamentals and other program constructs that can be referenced through a traditional pointer

3. A method in accordance with claims 1 and 2, wherein the Memory Item Headers (MIH) include information about the original memory item; said information to include at least the length of the original memory item or a biased version thereof and optionally additional information including:
a) Type information
b) Access rights
c) Reference counts
d) Object IDs

4. A method in accordance with any of the previous claims, wherein the Pointers to Intermediary Pointer Objects hold a reference to a newly disclosed Intermediary Pointer Object (IPO); said Intermediary Pointer Object having at least two parts:
a) A reference to a memory item's header (MIH)
b) An offset to a location in the memory item

5. A method according to claim 4 wherein said offset is with regard to the start of the original memory item or the start of its MIH

6. A method according to any of the previous claims wherein said Pointers to Intermediary Pointer Objects assume an IPO offset of zero and reference a MIH directly

7. A method according to any of the previous claims wherein said references have the same form as traditional pointers

8. A method according to any of the previous claims wherein said validating is characterised by checking that attempts to reference a memory item through a PIPO are consistent with the information held in the corresponding MIH and IPO

9. A method according to claim 8 wherein said consistency checking can include any of:
a) Bounds checking
b) Type checking
c) Access checking
d) Reference count checking

10. A method according to claim 9 wherein said bounds checking is further characterised by lower and upper bounds checking that may be applied together or independently

11. A method according to any of the previous claims wherein said validating is performed by instrumentation implemented in either:
a) Software or
b) Hardware

12. A method according to claim 11 wherein, said hardware instrumentation is implemented in the CPU of a computer system as new instructions or in modifications to the nucrocode for existing instructions

13. A method in accordance with any of the previous claims wherein run-time PIPOs are distinguished from traditional pointers by: registers reserved for PIPOs, memory areas reserved for IPOs, tags, maps, new CPU instructions or new address modes

14. A method according to any of the previous claims implemented as modifications to a compilation process, run-time libraries, functions, in-line macros, system calls, source translation or other means

15. A method or apparatus substantially as described herein

16. Apparatus configured or adapted to perform any one of the methods of the previous claims
